(19) United States
(12) Patent Application Publication
(10) Pub. No.: US 2006/0210722 A1
(43) Pub. Date: Sep. 21, 2006

(54) Radiation-hardening unsaturated polyester urethane resin

(75) Inventors: Florian Lunzer, Barcelona (ES); Rami-Raimund Awad, Graz (AU)

Correspondence Address: CONNOLLY BOVE LODGE & HUTZ, LLP, P O BOX 2207, WILMINGTON, DE, 19899, US

(73) Assignee: Cytec Surface Specialties Austria GmbH, Werndorf (AU)

(21) Appl. No.: 10/568,472

(22) PCT Filed: Aug. 20, 2004
(86) PCT No.: PCT/EP04/09338

§ 371 Date: Feb. 14, 2006

(30) Foreign Application Priority Data
Aug. 27, 2003 (AT) A 1347/2003

(51) Int. Cl. B05D 3/00; C08G 18/00

(52) U.S. Cl. 427/532; 528/44

(57) ABSTRACT

The invention relates to a coating agent, comprising reactive thinner (D), radiation-hardening unsaturated polyester urethane resins (ABC) with components derived from a polyester (A), multifunctional isocyanates (B) and olefinic unsaturated monomers (C) with hydroxy groups, methods for production and use thereof for coating substrates.

### FIELD OF THE INVENTION

The invention relates to a radiation-curable unsaturated polyesterurethane resin. It further relates to a process for its preparation and to its use as a binder for coatings, especially on metals.

### BACKGROUND OF THE INVENTION

Radiation-curable resins based on polyesterurethane acrylates are known e.g. from DE 198 35 849 A1. In contrast to these resins for powder coatings, the object is to provide resin solutions whose viscosity for a mass fraction of solids of over 50% makes it possible to apply them to substrates by spraying or rolling at room temperature (23° C.) with a high coating speed. Although the viscosity of such a coating agent can be reduced by adding reactive diluents, these are incorporated into the coating during radiation curing and lead to embrittlement and impairment of the adhesion to the substrate.

In the experiments that have let to the present invention, it was found that the incorporation of optionally unsaturated fatty acids into polyesterurethane acrylates reduced their viscosity and at the same time markedly improved the adhesion to substrates, especially metals.

The present invention provides radiation-curable unsaturated polyesterurethane resins ABC containing structural units derived from an optionally unsaturated polyester resin A, polyfunctional isocyanates B and olefinically unsaturated monomers containing hydroxyl groups, C. Coating agents are formulated by mixing the unsaturated polyesterurethane resins with reactive diluents D which contain at least one double bond per molecule that is copolymerisable with the unsaturated polyesterurethane resin, and which preferably has a hydroxyl number preferably of from 0 mg/g to 10 mg/g, particularly preferably of from 0 mg/g to 5 mg/g.

The polyester resins A contain structural units derived from dihydric linear, branched or cyclic aliphatic alcohols A1 having 2 to 20 carbon atoms, optionally polyoxyalkylene-polyols A1′ with alkylene groups having from 2 to 6 carbon atoms, preferably 2 to 4 carbon atoms, and number-average degrees of polymerisation of from 2 to 40, preferably of from 3 to 35, the latter preferably having an average of two hydroxyl groups per molecule, trihydric or more than trihydric aliphatic alcohols A2 having from 3 to 20 carbon atoms, at least dihydric aliphatic or aromatic acids A3 having from 2 to 40 carbon atoms, and optionally unsaturated fatty acids A4 having from 6 to 30 carbon atoms. The mass fraction of the components A1 to A4 in the condensation mixture for the preparation of the polyester A are preferably from 2% to 20%, from 5% to 40%, from 5% to 50% and from 15% to 60%, the sum of the mass fractions being 100% in each case. The mass fractions of the components A1 to A4 are preferably from 5% to 15%, from 10% to 30%, from 10% to 40% and from 20% to 50%.

Preferred components A1 are glycol, 1,2- and 1,3-propylene glycol, 1,4-butanediol, 1,6-hexanediol, 1,5-dihydroxy-3-oxapentane, 1,8-dihydroxy-3,6-dioxaoctane, neopentyl glycol, 1,4-dihydroxycyclohexane and 1,4-cyclohexane-dimethanol, as well as bicyclic and polycyclic aliphatic alcohols such as so-called “TCD alcohol” (octahydro-4,7-methano-1H-indenedimethanol).

Preferred polyoxyalkylenepolyols A1′ are oligoethylene and polyethylene glycol and oligopropylene and polypropylene glycol, as well as so-called poly-THF (oligo- and poly-1,4-butylene glycol). The number-average molar mass Mₙ of these polyoxyalkylenepolyols A1′ is preferably from 62 g/mol to 3000 g/mol, particularly preferably from 300 g/mol to 2000 g/mol.

Preferred components A2 are glycerol, trimethylolethane, trimethylolpropane, pentaerythritol, ditrimethylolethane, ditrimethylolpropane, dipentaerythritol, sorbitol and mannitol.

Preferred components A3 as dibasic acids are malonic acid, succinic acid, glutaric acid, adipic acid, pimelic acid, suberic acid, sebacic acid, phthalic acid, isophthalic acid, terephthalic acid, naphthalene-2,3-dicarboxylic acid, naphthalene-2,6-dicarboxylic acid and cyclohexane-dicarboxylic acid, preferred tribasic acids being trimellitic acid, trimesic acid and sulfoisophthalic acid; tetrabasic or more than tetrabasic acids, such as benzene-tetracarboxylic acid and benzophenonetetracarboxylic acid, can also be used in small fractions of up to 0.1 mol/mol, based on the amount of substance of acids A3.

Of course, anhydrides or other reactive derivatives of the acids A3, e.g. their methyl esters, can also be used, at least in part, in the polycondensation; likewise, esters of the alcohols A1 and/or A2 with volatile acids, such as acetic acid, can also be used, at least in part.

Preferred components A4 are palmitoleic acid, oleic acid, elaidic acid, erucic acid, sorbic acid, linoleic acid, linolenic acid, elaeostearic acid, arachidonic acid and clupanodonic acid. The mixtures of such fatty acids obtained from natural oils, such as linseed oil fatty acid, tall oil fatty acid, sunflower oil fatty acid, castor oil fatty acid, coconut oil fatty acid and peanut oil fatty acid, are also suitable.

The polyfunctional isocyanates B have at least two isocyanate groups and are preferably selected from linear, branched and cyclic aliphatic diisocyanates having from 4 to 12 carbon atoms in the alkylene radical, and aromatic diisocyanates having from 6 to 18 carbon atoms in the aryl radical, and allophanates, isocyanurates, biurets and uretdiones of the said isocyanates. 1,4-tetramethylene diisocyanate, 1,6-hexamethylene diisocyanate, isophorone diisocyanate, 2,4- and 2,6-toluylene diisocyanate, bis(4-isocyanatophenyl)methane and tetramethylxylylene diisocyanate, as well as the above-mentioned derivatives of these isocyanates, are preferred.

The olefinically unsaturated monomers containing hydroxyl groups, C, are selected from the group consisting of allyl alcohol, methallyl alcohol and the monoesters C2 of dihydric or more than dihydric alcohols, as mentioned under A1 and A2, with olefinically unsaturated monocarboxylic acids C21, such as acrylic acid, methacrylic acid, vinylacetic acid, crotonic acid and isocrotonic acid. Hydroxyethyl (meth)acrylate, 3-hydroxypropyl (meth)acrylate, 4-hydroxybutyl (meth)acrylate, 2-hydroxy-1-methylethyl (meth)acrylate and 2-hydroxy-2-methylethyl (meth)acrylate are preferred.

The reactive diluents D contain at least one double bond copolymerizable with the unsaturated polyesterurethane resin. They have a hydroxyl number preferably of from 0 mg/g to 10 mg/g, particularly preferably of from 0 mg/g to 5 mg/g. Preference is given to linear acetals of dihydric alcohols A1 which are esterified with two molecules of the acids mentioned under C21, and cyclic acetals of polyhydric alcohols A2 which are esterified with at least one molecule of one of the acids mentioned under C21. Trimethylolpropaneformal (meth)acrylate and pentaerythritolformal di(meth)acrylate are particularly preferred.

The unsaturated polyesterurethane resins ABC are prepared by polycondensation of the components A1 to A4 to give the polyester A, which is then reacted, preferably in the presence of a catalyst and a polymerisation inhibitor, with the reaction product BC of a polyfunctional isocyanate B and an unsaturated compound containing hydroxyl groups, C, the reactive isocyanate groups in BC being completely consumed. The reaction product BC has an average of at least one isocyanate group and at least one olefinic double bond.

The polycondensation is carried out at temperatures of 120° C. to 200° C., the reaction time being from two to twenty hours. Removal of the condensation product (water or, in the case of the reactive derivatives, lower alcohols or volatile acids) can be facilitated by adding an entrainment agent that forms an azeotrope with the water produced and is recycled after condensation and phase separation. When the reaction has ended, the entrainment agent is separated, preferably by distillation under reduced pressure.

The polyester A is then reacted with the separately prepared adduct of the isocyanate B and the unsaturated compound containing hydroxyl groups, C, wherein metal-organic compounds, such as dibutyltin dilaurate, organic titanium compounds or bismuth salts or chelates, are optionally added as catalysts. When urethane formation has ended (complete consumption of the isocyanate groups of BC), the reactive diluent D is preferably added, the mass fraction of solids being adjusted to from approx. 50% to approx. 70%, based on the mass of the liquid mixture of ABC and D. The reactive diluent can be added preferentially at the reaction temperature for the polycondensation because the mixture thus remains low viscosity and well stirrable.

The mixture of the unsaturated polyesterurethane resin and the reactive thinner can be applied in a thin layer of from 20 μm to 80 μm (dry layer thickness) to any substrates, preferably metals and especially base metals. A photo-initiator is conventionally added to accelerate curing by high-energy light or irradiation.

The coated substrate is then cured by irradiation with UV light or electron beams. The preferred substrates are metals, wood, paper, cardboard or plastics. The cured coatings exhibit an excellent adhesion to the substrate, especially to metals. The metal sheets coated in this way can be bent several times through 90° in the same place without the coating peeling off. The coating agents according to the invention are therefore particularly suitable for coating metal strips (coil coating) that are subsequently deformed by pressing, deep drawing or punching.

The Examples which follow illustrate the invention.

### EXAMPLES

### Example 1

### Preparation of a Polyester

62.1 g of glycol, 134.2 g of trimethylolpropane, 146.1 g of adipic acid and 280 g of peanut oil fatty acid were mixed and heated to 180° C. with the addition of 0.2 g of tin octoate and 30 g of methyl isobutyl ketone. The distillate was condensed and, after phase separation, the solvent was recycled. The acid number was below 5 mg/g after approx. 10 hours. The solvent was stripped off by distillation under reduced pressure to leave approx. 569 g of a polyester.

### Example 2

### Preparation of an Olefinically Unsaturated Monoisocyanate

174 g of toluylene diisocyanate were mixed with 116 g of hydroxyethyl acrylate at 25° C., with cooling. The mixture was carefully heated to 65° C. and kept at this temperature until the isocyanate concentration was constant.

### Example 3

### Preparation of a Coating Agent

100 g of the polyester of Example 1 were heated to 50° C. with 0.2 g of hydroquinone monomethyl ether and 0.2 g of dibutyltin dilaurate. 70 g of the unsaturated isocyanate of Example 2 were added in portions to this mixture. The temperature was kept below 80° C. by cooling. When the addition had ended, stirring was continued at 80° C. until isocyanate was no longer detectable (four hours). 113.4 g of trimethylolpropaneformal acrylate were then added and the resulting mixture was cooled to room temperature (23° C.). The mixture had a solids mass fraction of approx. 60% and a viscosity of 2980 mPa·s at 23° C. and 25 s⁻¹.

### Example 4

### Testing of the Coating

The coating agent of Example 3 and, for comparison, a commercially available polyesterurethane acrylate resin containing trimethylolpropaneformal acrylate as reactive diluent (mass fraction of solids: 55%) were formulated with 5 g of a photoinitiator (®Darocure 1173, benzophenone type) per 100 g of the binder containing reactive diluent. The viscosity at 23° C. and 25 s⁻¹ was 3000 mPa's for the coating agent of Example 3 and 7660 mPa's for the Comparative Example.

The pendulum hardness of the film (measured on a glass plate for a 50 μm layer thickness of the dry film) 24 h after curing was 83 s for the coating agent of Example 3 and 33 s for the Comparative Example.

A rust-protected bonderised metal sheet (steel sheet of ST 1405, untreated, ground on one side, Examples 4.1 and 4.1C) and a 26S/60/OC steel sheet (of ST 1405, spray-phosphatised, Examples 4.2 and 4.2C) were coated with these varnishes and the coatings were cured by irradiation with UV light from a mercury vapour lamp (power: 80 watt, distance: 10 cm, conveyor belt speed: 4 m/min). The wet film thickness was 50 μm in each case. Films with a wet film thickness of 8 μm were applied to other 26S/60/OC steel sheets (Examples 4.3 and 4.3C).

The following results were obtained:

TABLE 1
Mechanical testing of the coated metal sheets

| | | Example | | | | | |
|---|---|---|---|---|---|---|---|
| | | 4.1 | 4.1C | 4.2 | 4.2C | 4.3 | 4.3C |
| Erichsen cupping | in mm | 9 | 9 | 9 | 9.5 | 9.5 | 9 |
| Erichsen impact | in in · lb | 80; 80 | 80; 80 | 80; 80 | 80; 80 | 80; 80 | 80; 80 |
| | in J | 9.04; 9.04 | 9.04; 9.04 | 9.04; 9.04 | 9.04; 9.04 | 9.04; 9.04 | 9.04; 9.04 |
| Cross-hatch test | | 0; 0 | 0; 0 | 0; 0 | 0; 0 | 0; 0 | 0; 0 |
| T-bend | | 0 T | 2 T; 3 T | 0 T | 2 T; 3 T | 0 T | 2 T; 3 T |

(1 in · lb = 25.4 mm · 0.45359 kg · 9.81 m/s² = 113.0249 · 10⁻³ J = 0.1130249 J)

The Erichsen cupping test and the crosshatch test were performed and evaluated according to DIN EN ISO 1520 and DIN EN ISO 2409, respectively. The indicated cupping is the deformation (in mm) due to an impacting ball for which the varnish does not yet peel away from the deformed spot. A “0” in the crosshatch test means that none of the squares produced by crosshatch cutting of the cured varnish shows rupture points after the cuts have been covered with adhesive tape and the latter has been torn off.

The Erichsen impact test is performed according to ASTM D 2794. This indicates the energy of a falling ball for which the layer of varnish does not yet peel away from the bulge (side directed away from the ball impact point).

The T-bend was determined according to ASTM D 4145. TO means that there are no cracks when the substrate is bent through 180° and no loss of adhesion when the bend is covered with adhesive tape and the tape is torn off. Correspondingly, Tl etc. mean that there are no such damage characteristics when the substrate is bent flat twice, three times etc., in each case through 180°. The bending radius of the first bending is of course the smallest.

1. Radiation-curable unsaturated polyesterurethane resins ABC containing structural units derived from a polyester A, polyfunctional isocyanates B, and olefinically unsaturated monomers containing hydroxyl groups, C.

2. Radiation-curable unsaturated polyesterurethane resins ABC according to claim 1, characterised in that the polyesters A are derived from dihydric linear, branched or cyclic aliphatic alcohols A1 having from 2 to 20 carbon atoms, optionally trihydric or more than trihydric aliphatic alcohols A2 having from 3 to 20 carbon atoms, at least dibasic aliphatic or aromatic acids A3 having from 2 to 40 carbon atoms, and fatty acids A4 having from 6 to 30 carbon atoms.

3. Radiation-curable unsaturated polyesterurethane resins ABC according to claim 1, characterised in that the polyesters A additionally contain structural units of polyoxyalkylenepolyols A1′ with alkylene groups having 2 to 6 carbon atoms and number-average degrees of polymerisation of from 2 to 40.

4. Radiation-curable unsaturated polyesterurethane resins ABC according to claim 1, characterised in that the mass fractions of the components A1 to A4 in the condensation mixture for preparation of the polyester A are from 2% to 20%, from 5% to 40%, from 5% to 50% and from 15% to 60%, the sum of the mass fractions being 100% in each case.

5. Radiation-curable unsaturated polyesterurethane resins ABC according to claim 1, characterised in that the polyesters A have a hydroxyl number of from 0 mg/g to 150 mg/g and an acid number of from 5 mg/g to 200 mg/g.

6. Coating agents containing reactive diluents D and radiation-curable unsaturated polyesterurethane resins ABC according to claim 1.

7. Coating agents according to claim 6, characterised in that the reactive diluents D contain at least one double bond per molecule that is copolymerisable with the unsaturated polyesterurethane resin.

8. Coating agents according to claim 6, characterised in that the reactive diluents D have a hydroxyl number of from 0 mg/g to 10 mg/g.

9. Coating agents according to claim 6, characterised in that their mass fraction of solids is from 50% to 70%.

10. A method for coating substrates, comprising applying a coating agent according to claim 6 and curing of the coating by irradiating with high-energy radiation.
